(19) United States
(12) Patent Application Publication
(10) Pub. No.: US 2024/0176088 A1
(43) Pub. Date: May 30, 2024

(54) OPTICAL CABLE WITH DIELECTRIC STRENGTH ELEMENTS AND TONEABLE ELEMENT

(71) Applicant: CORNING RESEARCH & DEVELOPMENT CORPORATION, Corning, NY (US)

(72) Inventors: Bradley Jerome Blazer, Granite Falls, NC (US); Kenneth Darrell Temple, JR., Newton, NC (US)

(21) Appl. No.: 18/522,964

(22) Filed: Nov. 29, 2023

Related U.S. Application Data
(60) Provisional application No. 63/428,787, filed on Nov. 30, 2022.

(51) Int. Cl. G02B 6/44

(52) U.S. Cl. CPC G02B 6/4432

(57) ABSTRACT

An optical fiber cable includes a cable core, a cable jacket surrounding the cable core, a dielectric strength element embedded in the cable jacket, and a toneable element embedded in the cable jacket and positioned proximally to the dielectric strength element.

### RELATED APPLICATIONS

This application claims priority to U.S. Provisional Patent Application No. 63/428,787 filed on Nov. 30, 2022 and entitled “OPTICAL CABLE WITH DIELECTRIC STRENGTH ELEMENTS AND COPPER TONEABLE ELEMENT,” the entirety of which is incorporated herein by reference.

### BACKGROUND

Optical fiber cables generally include one or more optical fibers that are disposed within a cable jacket. Such optical fiber cables may include any of various additional elements such as strength members, water-blocking elements, buffer tubes, or the like, depending upon an application of the optical fiber cable. For instance, cables that are buried or otherwise disposed in such a manner as to be difficult to locate, have included toneable elements that facilitate detection by means other than line-of-sight. Conventionally, toneable elements have been included in optical fiber cables as messenger wires connected to a main body of the cable by a webbing of jacket material.

### SUMMARY OF THE DISCLOSURE

The following is a brief summary of subject matter that is described in greater detail herein. This summary is not intended to be limiting as to the scope of the claims.

Various technologies pertaining to an optical fiber cable that includes a toneable element are described herein. An exemplary optical fiber cable includes an optical fiber, a cable jacket that surrounds the optical fiber, and a strength element embedded in the cable jacket. In exemplary embodiments, the strength element is a dielectric strength element such as a glass-reinforced plastic (GRP) rod, an aramid-reinforced plastic (ARP) rod, or the like. The optical fiber cable further comprises a toning element that is embedded within the cable jacket and disposed proximal to the strength element. The toning element can be, for example, a stranded or solid wire formed of a conductive material (e.g., copper, steel, aluminum, etc.).

The above summary presents a simplified summary in order to provide a basic understanding of some aspects of the systems and/or methods discussed herein. This summary is not an extensive overview of the systems and/or methods discussed herein. It is not intended to identify key or critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 depicts a cross-sectional view of an exemplary cable having a toneable element embedded in a cable jacket;

FIG. 2 depicts a cross-sectional view of another exemplary cable having a toneable element embedded in a cable jacket;

FIG. 3 depicts a cross-sectional view of still another exemplary cable having a toneable element embedded in a cable jacket;

FIG. 4 depicts a cross-sectional view of yet another exemplary cable having a toneable element embedded in a cable jacket;

FIG. 5 depicts a cross-sectional view of an exemplary cable having a preferential bend; and

FIG. 6 is a flow diagram that illustrates an exemplary methodology for forming an optical fiber cable that has a toneable element embedded in its cable jacket.

### DETAILED DESCRIPTION

Various technologies pertaining to a toneable optical fiber cable are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices may be shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or”. That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Additionally, as used herein, the term “exemplary” is intended to mean serving as an illustration or example of something, and is not intended to indicate a preference.

Optical fiber cables described herein are suitable for applications where toning of a cable is desirable (e.g., when a cable is buried), but may exhibit various advantages relative to other designs of toneable optical fiber cables. For instance, the optical fiber cables described herein do not rely for toning on a messenger wire connected to a cable jacket by a webbing. Thus, optical fiber cables described herein may be manufactured or handled with simpler tooling and equipment downstream of jacketing without risking damage to a portion of a cable containing a messenger wire.

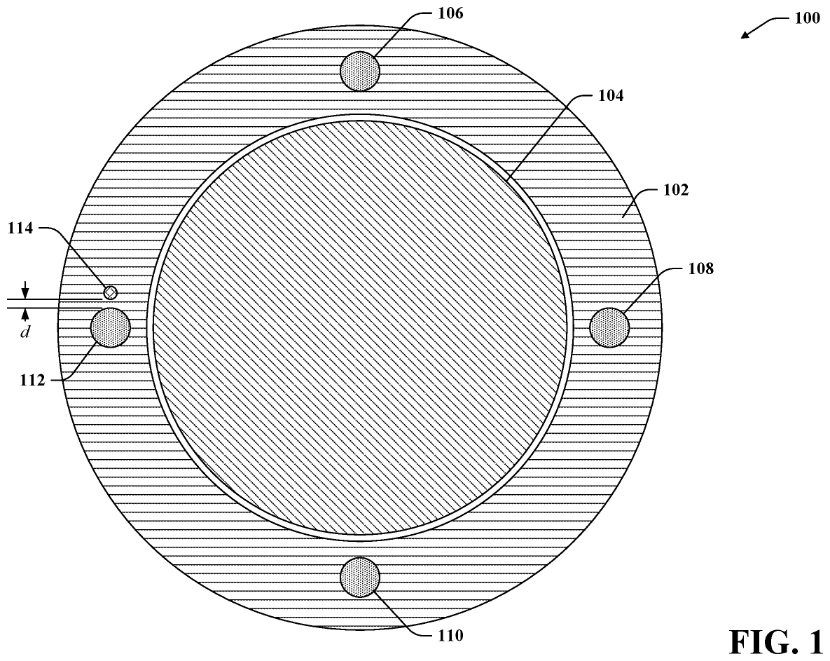

Referring now to FIG. 1, an exemplary optical fiber cable 100 having a toneable element is illustrated in cross-section. The cable comprises a cable jacket 102, a cable core 104, dielectric strength elements 106-112, and a toneable element 114. The cable core 104 includes one or more optical fibers (not separately depicted) that are configured to allow propagation of optical signals on which are encoded various types of data (e.g., voice, video, Internet traffic, etc.).

The cable jacket 102 can be or include any of various polymeric materials such as various polyethylenes (e.g., LDPE, MDPE, or HDPE) or other polyolefins, polycarbonates (PC), polybutylene terephthalate (PBT), polyvinyl chloride (PVC), polyethylene terephthalate (PET), among others.

The cable core 104 can be configured in various ways and include any of various elements such as water-blocking powders, tapes, or yarns, binder yarns or films, interior jackets, foam elements, etc. In a non-limiting example, the cable core 104 comprises a plurality of buffer tubes that each have one or more optical fibers disposed therein. These buffer tubes may be relatively thick (e.g., average thickness of 350 microns or greater). In various embodiments, buffer tubes in the cable core 104 may be stranded together (e.g., helically stranded or S-Z stranded).

In another example, the cable core 104 comprises a plurality of subunits wherein each subunit comprises a group of optical fibers surrounded by a thin polymeric membrane that is continuous in a longitudinal and circumferential direction. In various embodiments, such membrane can have an average thickness of less than or equal to 100 microns, less than or equal to 75 microns, less than or equal to 50 microns, or less than or equal to 30 microns. Subunits may be stranded together or may be positioned in the cable core 104 without stranding. In some embodiments, a subunit can comprise a group of optical fibers bound together by a binder yarn or string that is wound about the group of optical fibers.

The optical fibers in the cable core 104 can be “loose” fibers (i.e., not connected to one another by a matrix material) or can be “ribbonized” into one or more optical fiber ribbons. In embodiments wherein the optical fibers of the cable core 104 are disposed in optical fiber ribbons, the optical fiber ribbons can be planar and substantially rigid. In other embodiments, the optical fiber ribbons can be “rollable” ribbons in which the optical fibers can be arranged in a substantially planar “unrolled” state, and can also be rolled, folded, or otherwise deflected into a “rolled” state. In various embodiments, such a rollable ribbon can be formed from a material that covers substantially the entirety of the optical fibers of the ribbon but that is sufficiently flexible to allow the ribbon to be manipulated into the rolled state. In further embodiments, a rollable ribbon can be formed by intermittently bonding optical fibers along the length of the ribbon such that one or more of the optical fibers of the ribbon is connected to an adjacent optical fiber along some portions of their lengths and unconnected along other portions of their lengths.

The strength elements 106-112 are embedded in the cable jacket 102 and provide strength to the cable 100 against various forces that may be applied to the cable 100 during installation or in its deployed environment. The strength elements 106-112 may further provide stiffness to the cable 100 to improve the jetting performance of the cable 100 (e.g., by increasing the distance that the cable 100 can be jetted through a duct).

In various embodiments, the cable 100 can be configured as an all-dielectric cable that lacks elements that are highly conductive, such as, for example, metal armor. In such an all-dielectric embodiment, the strength elements 106-112 are dielectric strength elements such as GRP or ARP rods. In the past, toneable versions of optical fiber cable designs have incorporated conductive strength elements such as steel wires or rods, thereby providing both strength and toneability to an optical fiber cable. However, the inventors have observed that such conductive strength elements commonly exhibit poor bonding to polymeric cable jackets and typically require additional expensive coatings to meet the performance needs of practical optical fiber cables.

The cable 100 includes dielectric strength elements 106-112. The cable 100 further includes a toneable element 114 that is embedded in the cable jacket 102 and disposed proximal to one of the strength elements 106-112 (e.g., strength element 112 as shown in FIG. 1). The toneable element 114 can be a conductive wire. In some embodiments, the toneable element 114 is a solid conductive wire. In other embodiments, the toneable element 114 comprises a stranded conductive wire that is composed of smaller, individual strands. The inventors have observed that employing a stranded wire that has an undulating or bumpy exterior profile as the toneable element 114 can improve mechanical coupling between the stranded wire and the cable jacket 102 relative to a solid, smooth conductive wire, thereby inhibiting undesired longitudinal movement of the toneable element 114 within the cable jacket 102.

In various embodiments, the toneable element 114 is composed primarily of copper, primarily of steel, or primarily of aluminum. In an exemplary embodiment, the toneable element 114 comprises a wire that is composed of a metal alloy. In another embodiment, the toneable element 114 comprises a tinned wire that is composed primarily of a first metal, wherein the tinned wire is further coated with a second metal. For example, the toneable element 114 can comprise a copper wire that is tinned with a corrosion-resistant metal.

The toneable element 114 is disposed proximal to one of the strength elements 106-112. Embedding the toneable element 114 in the cable jacket 102 proximally to one of the strength elements 106-112 can facilitate inclusion of the toneable element 114 in the cable 100 without altering the shape of the cable jacket 102. Thus, for example, the cable 100 can have a substantially circular cross-section without the need for protrusions to accommodate the toneable element 114 (such as those used for messenger wires).

In non-limiting examples, the toneable element 114 can be disposed within a threshold distance of one or more of the strength elements 106-112. For instance, the toneable element 114 can be positioned within a threshold distance that is a multiple of a radius of one of the strength elements 106-112 to which the toneable element 114 is proximal. By way of further illustration, the toneable element 114 is positioned proximal to the strength element 112, the strength element 112 has a radius r, and the toneable element 114 is disposed within the cable jacket 102 within a distance d of the strength element 112, wherein d is a shortest distance between outer surfaces of the strength element 112 and the toneable element 114. In non-limiting examples, d is less than or equal to twice the radius r, d is less than or equal to 1.5 times the radius r, or dis less than or equal to the radius r.

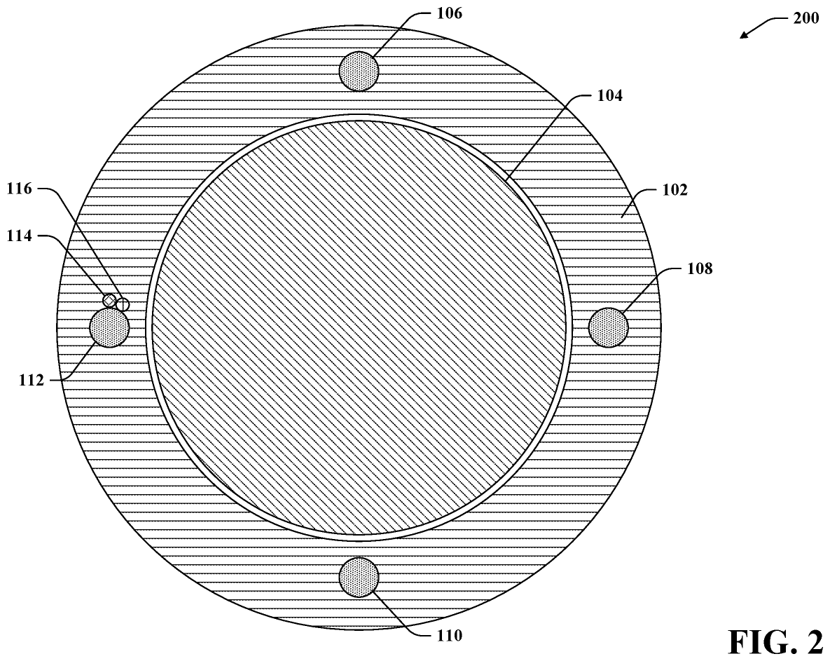

The toneable element 114 can in some embodiments be positioned directly adjacent to the strength element 112 such that the toneable element 114 is in physical contact with the strength element 112. For example, referring now to FIG. 2, another exemplary cable 200 is shown. The cable 200 is substantially identical to the cable 100, but the toneable element 114 is positioned in direct contact with the strength element 112. In various embodiments, the cable jacket 102 is extruded about the strength element 112 and the toneable element 114 simultaneously such that the toneable element 114 and the strength element 112 are tightly surrounded by the cable jacket 102. Stated differently, the strength element 112 and the toneable element 114 are completely embedded in the material of the cable jacket 102 while being in contact with one another along their respective lengths.

In various embodiments, the strength element 112 to which the toneable element 114 is proximal can have an exterior coating of ethylene acrylic acid copolymer (EAA). The EAA coating of the strength element can improve adhesion between the cable jacket 102 and the strength element 112 (and any of the other strength elements 106-110). It has further been observed that, in embodiments wherein the toneable element 114 is disposed in contact with the strength element 112 (e.g., as in the cable 200), the EAA coating of the strength element 112 is sufficient to prevent water penetration along a length of the cable 100 (i.e., looking into the page of FIG. 2) without additional coating of the toneable element 114. In various embodiments of the cable 100, however, the toneable element 114 (or a cavity in the cable jacket 102 within which such toneable element 114 is disposed) can be coated in a water-blocking material such as a superabsorbent polymer (SAP) powder. In addition, or in the alternative, a water-blocking thread or yarn 116 can be included adjacent to the toneable element 114.

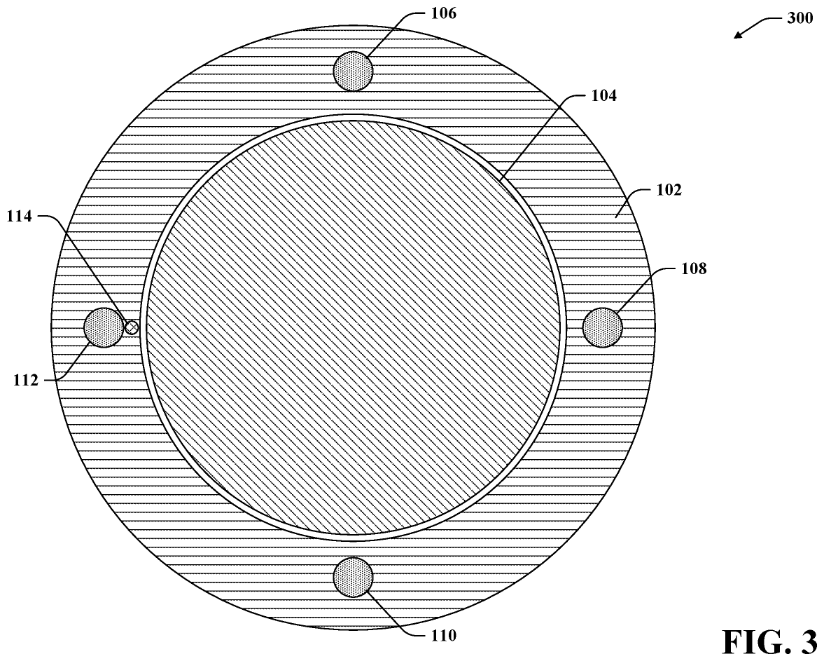

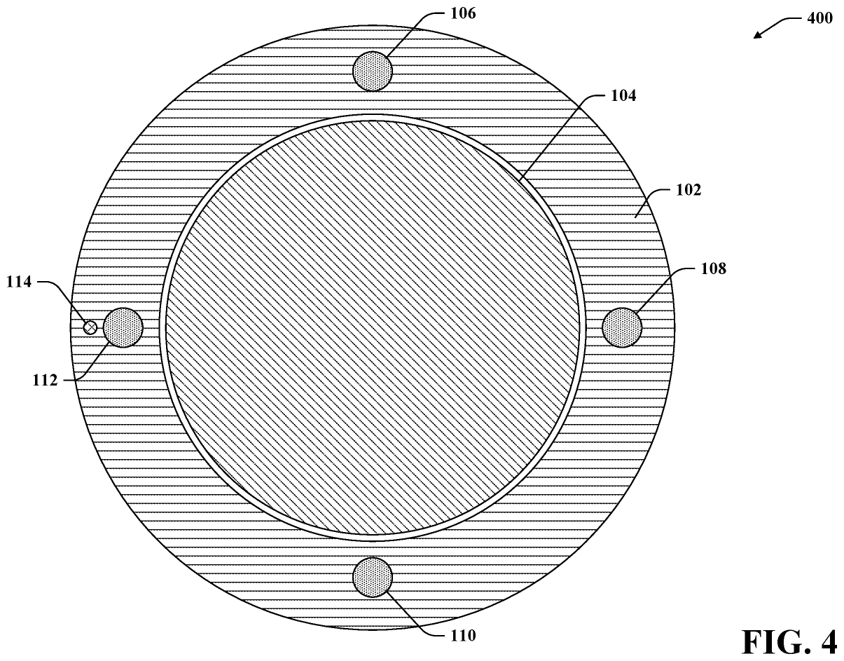

Referring now to FIGS. 3 and 4, alternative placements of the toneable element 114 are illustrated. FIG. 3 depicts an optical fiber cable 300 that is substantially identical to the optical fiber cable 100 of FIG. 1, but in which the toneable element 114 is positioned between the cable core 104 and the dielectric strength element 112 to which the toneable element 114 is closest. FIG. 4 depicts an optical fiber cable 400 that is substantially identical to the optical fiber cables 100, 300, but in which the toneable element 114 is positioned such that the dielectric strength element 112 is positioned between the toneable element 114 and the cable core 104.

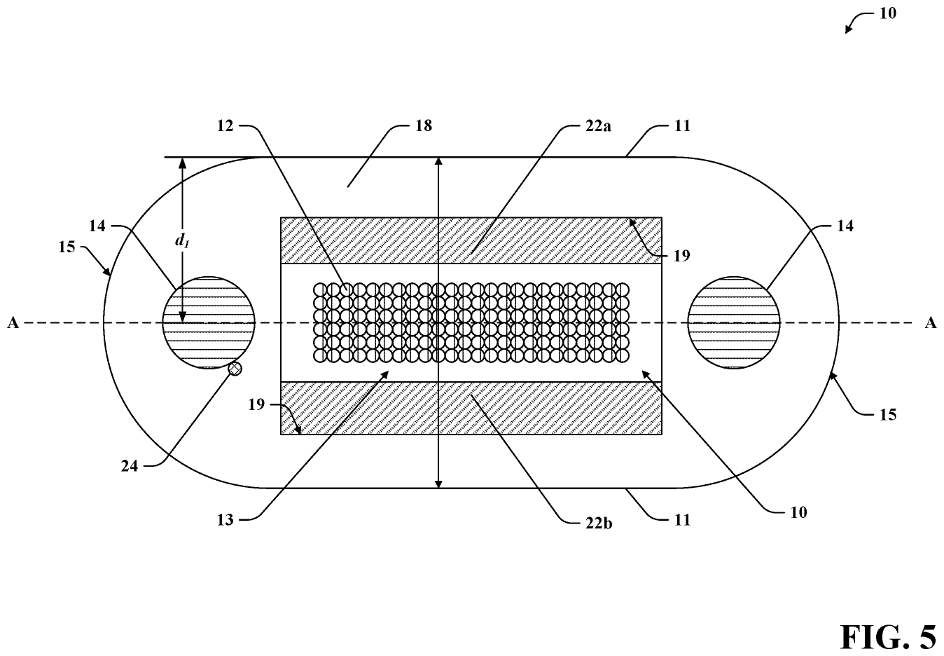

FIG. 5 depicts another exemplary optical fiber cable 10 (hereinafter cable 10) according to the present invention that can be configured for use as a drop cable, a distribution cable, or other suitable portions of an optical network. A distribution cable will generally have a relatively high optical fiber count such twelve or more optical fibers for further distribution to the optical network. On the other hand, a drop cable will have a relatively low optical fiber count such as up to four optical fibers for routing towards a subscriber or a business. However, drop cables may include higher fiber counts.

Cable 10 generally includes at least one optical fiber 12 disposed as a portion of an optical fiber ribbon 13, at least one strength element 14, and a cable jacket 18 having a cavity 20 configured with a generally flat profile. Cable 10 has two major surfaces 11 that are generally flat and are connected by arcuate end surfaces 15 as shown, thereby resulting in a cable having a relatively small cross-sectional footprint. As shown in FIG. 5, at least one optical fiber 12 is arrayed with a plurality of other optical fibers as a portion of optical fiber ribbon 13. The cable 10 can include a plurality of such ribbons 13, forming a ribbon stack. Cable 10 includes two strength elements 14 disposed on opposing sides of cavity 20, thereby imparting a preferential bend characteristic to cable 10. Strength elements 14 may be formed from a dielectric material such as GRP or ARP. Cavity 20 is sized for allowing ribbons 13 the adequate freedom to move when, for instance, the cable is bent while maintaining adequate optical attenuation performance of the optical fibers within the cable. Simply stated, the cavity is not tightly drawn onto the optical fiber but allows some movement. Additionally, jacket 18 may be formed from a flame-retardant material, thereby making it suitable for indoor applications such as multi-dwelling units (MDUs).

The cavity 20 of cable 10 can be easily accessed from either of the generally planar sides 11 of the cable, thereby allowing access to a desired one of the optical fibers 12. For instance, ribbons from either side of a ribbon stack, i.e., top or bottom, can be accessed by opening the cable 10 at the respective planar side. Consequently, the craftsman is able to access to any optical fiber desired for optical connection. As depicted, cavity 20 has a generally rectangular shape with a fixed orientation, but other shapes and arrangements are possible such as generally square, round, or oval. By way of example, cavity 20 may be rotated or stranded in any suitable manner along its longitudinal length. The cavity 20 can also have a partial oscillation through a given angle, for instance, the cavity 20 can rotate between a clockwise angle that is less than a full rotation and then rotate counterclockwise for less than a full rotation (looking along a length of the cable 10). Furthermore, the cavity 20 may be offset from a center of the cable 10 towards one of the major surfaces 11, thereby allowing easy opening and access from one side.

The cavity 20 has a minor dimension extending along a direction 17 between the two major surfaces 11. In various embodiments, the cavity 20 is centered between the major surfaces 11 along the direction 17. In such embodiments, the minor dimension of the cavity 20 can be larger than a diameter of the strength elements 14. The craftsman or an automation process has simple and easy access to cavity 20 by running a utility blade or cutting tool along the length of the cable without cutting into strength elements 14, thereby allowing entry to cavity 20 while inhibiting damage to the at least one optical fiber 12 or the strength elements 14 during the access procedure. In other words, the craftsman can simply cut into cable jacket 18 by slicing the cable jacket 18 and may use strength members 14 as a guide for the blade or cutting tool, thereby exposing cavity 20 during the cutting and allowing access to the at least one optical fiber therein.

Optical fiber ribbons 13 used in the cables of the present invention can have any suitable design or ribbon count. FIG. 5 depicts a stack of optical fiber ribbon 13 each with twenty-four optical fibers 12. The ribbon 13 may be a planar ribbon comprising fibers aligned parallel in a plane and surrounded by a matrix material. The ribbon 13 may be composed of a plurality of subunits, each having four of the optical fibers 12, for example. In such embodiments, the subunits can allow predetermined splitting of the ribbons 13 into predictable smaller fiber count units without the use of special tools. In an exemplary embodiment, the ribbons 13 can have pre-engineered weak points in the matrix material along subunit boundaries to facilitate splitting of the ribbons 13 into the distinct subunits. However, the ribbons 13 may not include subunits and subunits may have different fiber counts (e.g., a ribbon 13 can be divided into subunits having 6 fibers, 8 fibers, or 12 fibers). In addition, the ribbons 13 may be rollable or flexible ribbons, whereby rather than a matrix material completely surrounding the plurality of fibers, intermittent bonds or other configurations may be used so that the ribbon may be bent or flexed from a generally flat shape longitudinally to a rolled shape.

As also shown in FIG. 5, a plurality of dry inserts 22a, 22b may be disposed within the cavity 20 of the cable jacket 18. As depicted, major (e.g. planar) surfaces (not numbered) of dry inserts 22a, 22b are generally aligned with major (e.g. horizontal) surfaces 19 of cavity 20, thereby allowing a compact and efficient configuration while generally inhibiting corner fiber contact as may occur with a ribbon stack in a round tube, where stresses on the corner fibers of a ribbon or a ribbon stack in a round tube may cause the cable to fail optical performance requirements such as occurs during bending. Dry inserts 22a, 22b act to couple, cushion, and allow movement and separation of the ribbons (or optical fibers) to accommodate bending of cable 10.

Dry inserts 22a, 22b may be any suitable material such as a compressible layer of, for instance, foam tape for cushioning, coupling, allowing movement of and accommodating bending of the ribbon(s) (or optical fiber(s)) within cavity 20, or other suitable materials. As depicted, dry inserts 22a, 22b may optionally also include a water-swellable layer for blocking the migration of water along cavity 20. By way of example, the dry inserts 22a, 22b may include a water-swellable tape that is laminated to a compressible layer such as an open-cell polyurethane foam tape, but of course other suitable materials and construction are possible for dry insert(s). Likewise, various cables of the present invention may have a dry insert and a separate water blocking component such as a water-swellable yarn or thread disposed within the cavity. In other words, the dry insert and water blocking component may be separate components. A water-swellable layer included in dry inserts 22a, 22b generally faces the interior surfaces 19 of the cavity 20 such that the water-swellable layer is separated from the optical fibers 12 or ribbons 13, but in other embodiments the water-swellable layer may face the optical fibers 12 or ribbons 13. In other embodiments, the dry inserts 22a, 22b may be a single insert that, for example, completes wraps around the perimeter of the cavity 20.

In embodiments of the cable 10 wherein the strength elements 14 are dielectric, cable 10 may be substantially dielectric in nature. Cable 10 includes a toneable element 24 that is useful for locating the cable 10 in buried applications. In similar manner to the cables 100, 200, 300, 400 described above, the toneable element 24 may be a conductive wire disposed entirely within the extruded jacket 18 of cable 10.

As indicated above, the cable 10 is characterized by a preferential bend due to the positioning of the strength elements 14. The toneable element 24 is positioned proximal to one of the strength elements 14 (e.g., within a threshold distance of the strength element 14, within a distance defined by a multiple of a radius of the strength element 14, or in direct contact with the strength element 14). The placement of the toneable element 24 protects the toneable element 24 from undue strain in bending by keeping it near the neutral axis of the cable 10 while taking advantage of the relatively thick region of the jacket 18 adjacent to the strength element 14 to avoid affecting the form factor of the cable 10. The placement is further optimized by placing the toneable element 24 where the extruded velocity of the compound comprising the jacket 18 matches the velocity of the strength element 14 at the extrusion die exit, thus avoiding undue disturbance of the extruded shape of the cable jacket 18.

In some embodiments, the toneable element 24 can be centered at a position that is located on the preferential neutral bending axis (shown as A-A in FIG. 5). In various other embodiments, the toneable element 24 may not be located directly on the neutral axis of the cable 10 (A-A). Accordingly, the toneable element 24 may experience some positive or negative strain when the cable 10 is bent, depending on the bend direction. To mitigate the potential for strain on the toneable element 24, the toneable element 24 can be centered at a position that is within a threshold distance of the neutral axis (A-A). In various exemplary embodiments, the threshold distance is a function of a distance d₁ between the neutral axis (A-A) and an outer surface of the cable 10 (e.g., either of the major surfaces 11). By way of example, and not limitation, the threshold distance can be one third of the distance d₁, one quarter of the distance d₁, one fifth of the distance d₁, or one tenth of the distance d₁. It is to be appreciated that the distance d₁ is dependent upon an outer profile of an optical fiber cable and a location of the neutral bending axis of such cable. For instance, the distance d₁ will be equal to the radius of a round cable with a preferential bend that has its neutral bending axis running through the center of the round cable.

In embodiments wherein a cable is characterized by a preferential bend, the toneable element 24 may be a stranded conductive wire, which may provide reduced compressive strength due to each smaller stranded wire making up the stranded conductive wire being able to buckle independently. Furthermore, and as indicated above, the non-smooth outer profile of a stranded conductive wire can improve mechanical coupling between the toneable element 24 and the cable jacket 18. Both advantages can help to prevent a buckling failure where the whole toneable element 24 could penetrate the nearest wall of the cable jacket 18. In the position shown in FIG. 5, such a failure could damage or deform one of the optical fibers 12. In other positions (e.g., a position wherein the toneable element 24 is positioned on an opposite side of the strength element 14 as the cavity 20), such a failure could cause the toneable element 24 to protrude out from an exterior of the cable jacket 18. Alternatively, a toneable element 24 comprising a solid wire may be used to prevent such a failure. A solid wire toneable element 24 may have a strong adhesive bond to the jacket 18, but in many cases may be more expensive.

A toning distance suitable for common deployments of optical fiber cables application may be achieved using toneable elements 114, 24 that comprise a 24-gauge copper wire (e.g., a 24-gauge stranded copper wire with seven 32-gauge wires stranded together). A more finely-stranded toneable element 24, e.g. with nineteen stranded 40-gauge wires, may further enhance the anti-buckling performance. Other gauge sizes may also be chosen to tailor the required toning distance for each application. A 24-gauge copper wire has an expected toning distance of 11 miles, which covers the length of most cables typically offered today. However, a 28-gauge wire could save material cost, and tone for a shorter distance that covers more standard cable lengths.

During the typical manufacture of the preferential bend cable 10 depicted in FIG. 5, the strength elements 14 may be tensioned during the extrusion process, with the tension being released after the extruded jacket 18 has cooled. This ‘stretch and release’ generates positive excess length in the optical fibers 12. Depending on the specific design and fiber count, the excess fiber length, or excess ribbon length in the case of a ribbon, may be in the range of 0% to 1.0%, and is commonly around 0.8%. The toneable element 24 in the cable 10 also causes excess fiber or ribbon length as the process tension is released. Again, when the toneable element 24 is a stranded wire, the resulting compression will be absorbed along the length of each helically wrapped strand rather than as a kink in the composite as a whole. Further, the inherent excess length will prevent excessive tensile strain of the toneable wire strands during cable installation and lifetime events including bending, high tension, and thermal cycling.

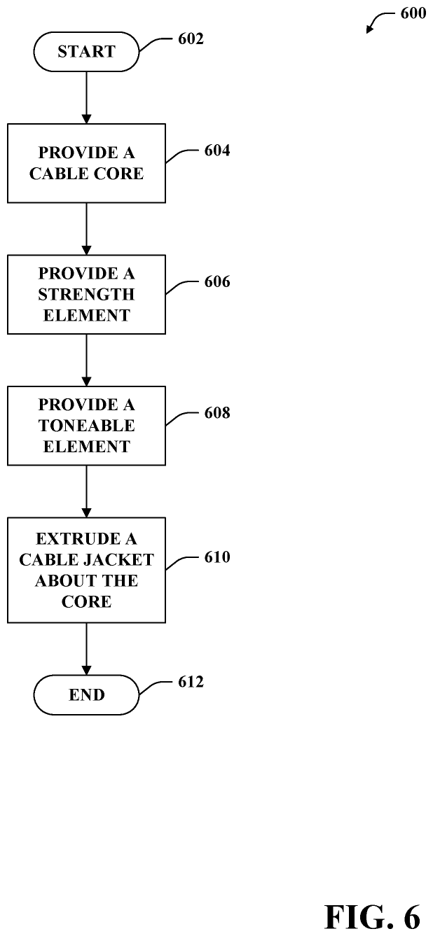

FIG. 6 illustrates an exemplary methodology 600 relating to forming an optical fiber cable having a cable jacket with a toneable element embedded therein. While the methodology is shown and described as being a series of acts that are performed in a sequence, it is to be understood and appreciated that the methodology is not limited by the order of the sequence. For example, some acts can occur in a different order than what is described herein. In addition, an act can occur concurrently with another act. Further, in some instances, not all acts may be required to implement a methodology described herein.

The methodology 600 begins at 602 and at 604 a cable core is provided. The cable core can be or include any of various elements of an optical fiber cable such as various embodiments of the cable core 104 described above, or the optical fiber ribbons 13 and dry inserts 22a, 22b shown in the cavity 20 of the optical fiber cable 10. At 606, a strength element is provided. The strength element provided at 606 can be a dielectric strength element such as a GRP or ARP rod. At 608 a toneable element is provided 608, wherein the toneable element is electrically conductive (e.g., a conductive metal wire). At 610 a cable jacket is extruded about the core, the strength element, and the toneable element such that the strength element and the toneable element are embedded in the cable jacket, and the toneable element is positioned proximally to the strength element within the cable jacket.

What has been described above includes examples of one or more embodiments. It is, of course, not possible to describe every conceivable modification or alteration of the above systems, devices, or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An optical fiber cable, comprising:
a cable jacket having an interior surface that defines an interior cavity of the optical fiber cable;
a cable core disposed within the interior cavity, the cable core comprising an optical fiber;
a dielectric strength element embedded in the cable jacket; and
a toneable element embedded in the cable jacket and disposed proximal to the strength element.

2. The optical fiber cable of claim 1, wherein the dielectric strength element comprises a glass-reinforced plastic (GRP) rod.

3. The optical fiber cable of claim 1, wherein the dielectric strength element comprises an aramid-reinforced plastic (ARP) rod.

4. The optical fiber cable of claim 1, wherein the toneable element comprises a conductive wire.

5. The optical fiber cable of claim 4, wherein the conductive wire is a stranded wire.

6. The optical fiber cable of claim 4, wherein the conductive wire is a solid wire.

7. The optical fiber cable of claim 4, wherein the conductive wire is composed primarily of copper.

8. The optical fiber cable of claim 1, wherein the toneable element is directly adjacent to the dielectric strength element such that the toneable element is in contact with the dielectric strength element.

9. The optical fiber cable of claim 1, wherein the toneable element is positioned between the dielectric strength element and the interior cavity.

10. The optical fiber cable of claim 1, wherein the dielectric strength element is positioned between the toneable element and the interior cavity.

11. The optical fiber cable of claim 1, wherein the dielectric strength element has a radius, and wherein a distance between an exterior of the dielectric strength element and the toneable element is less than twice the radius.

12. The optical fiber cable of claim 11, wherein the distance between the exterior of the dielectric strength element and the toneable element is less than the radius.

13. The optical fiber of claim 1, wherein the optical fiber cable is characterized by a preferential bend, and wherein the toneable element is centered at a position that lies on a neutral axis of the optical fiber cable.

14. The optical fiber cable of claim 1, wherein the optical fiber cable is characterized by a preferential bend, and wherein the toneable element is centered at a position that is less than or equal to a threshold distance away from a neutral axis of the optical fiber cable, wherein the threshold distance is equal to one third of a distance between the neutral axis and an exterior surface of the optical fiber cable.

15. The optical fiber cable of claim 1, wherein the cable jacket has a substantially circular cross-sectional profile when looking down a length of the optical fiber cable.

16. The optical fiber cable of claim 1, wherein the cable jacket has a rounded rectangular cross-sectional profile when looking down a length of the optical fiber cable.

17. A method comprising:
providing a cable core, the cable core comprising at least one optical fiber;
providing a strength element;
providing a toneable element;
extruding a cable jacket around the cable core, the strength element, and the toneable element such that the strength element and the toneable element are embedded in the cable jacket and the toneable element is disposed proximal to the strength element.

18. The method of claim 17, wherein the cable jacket is extruded around the cable core such that the toneable element is in direct contact with the strength element.

19. The method of claim 17, wherein the toneable element comprises a conductive wire.

20. The method of claim 19, wherein the toneable element comprises a stranded wire.
